(19) United States
(12) Patent Application Publication
(10) Pub. No.: US 2018/0156166 A1
(43) Pub. Date: Jun. 7, 2018

(54) INTAKE MANIFOLD FOR INTERNAL COMBUSTION ENGINE

(71) Applicant: TOYOTA JIDOSHA KABUSHIKI KAISHA, Toyota-shi (JP)

(72) Inventors: Koji MIZOGUCHI, Toyota-shi (JP); Takahiro GOTO, Okazaki-shi (JP)

(73) Assignee: TOYOTA JIDOSHA KABUSHIKI KAISHA, Toyota-shi (JP)

(21) Appl. No.: 15/821,980

(22) Filed: Nov. 24, 2017

(30) Foreign Application Priority Data
Dec. 7, 2016 (JP) 2016-237733

(51) Int. Cl. F02M 35/104

(52) U.S. Cl. CPC F02M 35/104

(57) ABSTRACT

An intake manifold includes: a surge tank extending in a cylinder arrangement direction; an air introduction port provided in one end, in a longitudinal direction of the surge tank, of the surge tank extending in the cylinder arrangement direction and configured to introduce air into the surge tank; and a gas introduction passage opened inside the surge tank on an intake-air downstream side of the air introduction port, the gas introduction passage being configured to introduce blowby gas of an internal combustion engine into the surge tank. The gas introduction passage extends in the same direction as the longitudinal direction of the surge tank.

### INCORPORATION BY REFERENCE

The disclosure of Japanese Patent Application No. 2016-237733 filed on Dec. 7, 2016 including the specification, drawings and abstract is incorporated herein by reference in its entirety.

### BACKGROUND

### 1. Technical Field

The present disclosure relates to an intake manifold for an internal combustion engine.

### 2. Description of Related Art

An intake manifold for an internal combustion engine is provided with a surge tank, and blowby gas is introduced into the surge tank from a crankcase of the internal combustion engine. An intake manifold described in Japanese Patent Application Publication No. 2013-24229 (JP 2013-24229 A) includes an air introduction port configured to introduce air into a surge tank, and a gas introduction passage having an opening through which blowby gas is introduced into the surge tank.

### SUMMARY

In the intake manifold described in JP 2013-24229 A, the gas introduction passage extends in a direction inclined relative to a longitudinal direction of the surge tank. If an inclination angle of such a gas introduction passage is large, the blowby gas introduced into the surge tank from the opening of the gas introduction passage flows to an intake-air upstream direction in the surge tank by a turbulent flow and the like caused in the surge tank, which might cause the blowby gas to flow into the air introduction port.

The present disclosure provides an intake manifold for an internal combustion engine, the intake manifold being capable of restraining an inflow of blowby gas into an air introduction port.

An intake manifold for an internal combustion engine, for solving the above problem, includes a surge tank extending in a cylinder arrangement direction of the internal combustion engine. The surge tank includes an air introduction port configured to introduce air into the surge tank. The air introduction port is provided in one end, in a longitudinal direction of the surge tank, of the surge tank extending in the cylinder arrangement direction. The surge tank includes a gas introduction passage configured to introduce blowby gas of the internal combustion engine into the surge tank. The gas introduction passage is opened inside the surge tank on an intake-air downstream side relative to the air introduction port. The gas introduction passage extends in the same direction as the longitudinal direction of the surge tank.

The air introduced into the surge tank from the air introduction port flows in the longitudinal direction of the surge tank toward the intake-air downstream side. In this configuration, the gas introduction passage extends in the same direction as the longitudinal direction of the surge tank and does not extend in a direction inclined to the longitudinal direction of the surge tank. Accordingly, a flow direction of the blowby gas right after introduction into surge tank from the opening of the gas introduction passage becomes the same as a flow direction of the air flowing through the surge tank in the longitudinal direction, so that the blowby gas flows toward the intake-air downstream side together with the air right after the blowby gas is introduced into the surge tank from the opening. Accordingly, the blowby gas introduced into the surge tank from the opening of the gas introduction passage can hardly flow toward an intake-air upstream side of the surge tank, thereby resulting in that an inflow of the blowby gas into the air introduction port can be restrained.

In the intake manifold, the surge tank may include a rib provided inside the surge tank to define the gas introduction passage. The rib may be provided over an inner peripheral surface of the surge tank. With the configuration, the inner peripheral surface of the surge tank is reinforced by the rib that sections the gas introduction passage, thereby making it possible to increase rigidity of the surge tank. This accordingly makes it possible to raise withstand voltage performance of the surge tank, for example.

In the intake manifold, a throttle body including a throttle valve may be attached to an intake-air upstream side of the air introduction port. In a case where the throttle body including the throttle valve is attached to the intake-air upstream side of the air introduction port, if the blowby gas introduced into the surge tank flows into the air introduction port, the following inconvenience might be caused.

That is, if the blowby gas flowing into the air introduction port reaches the throttle body attached to the intake-air upstream side of the air introduction port, the throttle valve and an intake passage near the throttle valve are exposed to the blowby gas. Here, under a low temperature environment, steam included in the blowby gas might be turned into condensed water and then frozen. Accordingly, when the blowby gas reaches the throttle body under such a low temperature environment, condensed water derived from the blowby gas attached to the throttle valve and the intake passage near the throttle valve is frozen, which might cause malfunction of the throttle valve.

In this regard, according to the intake manifold of this aspect, it is possible to restrain the inflow of the blowby gas into the air introduction port, thereby making it possible to restrain an occurrence of the malfunction of the throttle valve as described above.

In the intake manifold, a sensing portion of a sensor may be provided on an outer wall of the surge tank, the outer wall being positioned on an extension line of the gas introduction passage in an opening direction, and the surge tank may include a wall projecting from an inner peripheral surface of the surge tank and provided between an opening of the gas introduction passage opened inside the surge tank and the sensing portion.

If the sensing portion of the sensor is provided on the outer wall of the surge tank, the outer wall being positioned on the extension line of the gas introduction passage. The extension line extends in a direction in which the opening of the gas introduction passage opens. The sensing portion of the sensor is easily exposed to the blowby gas. Here, as described above, under a low temperature environment, steam included in the blowby gas might be turned into condensed water and then frozen. Accordingly, when the sensing portion of the sensor is exposed to the blowby gas under such a low temperature environment, condensed water derived from the blowby gas attached to the sensing portion of the sensor might be frozen, so that detection accuracy of the sensor might decrease. In this regard, in the configuration, the wall projecting from the inner peripheral surface of the surge tank is provided between the opening of the gas introduction passage and the sensing portion of the sensor. Since the wall restrains the sensing portion of the sensor from being exposed to the blowby gas, it is possible to restrain the decrease of the detection accuracy of the sensor. Further, the wall projecting from the inner peripheral surface of the surge tank functions as a rib that reinforces the inner peripheral surface of the surge tank, thereby making it possible to increase rigidity of the surge tank. Accordingly, vibrations of the surge tank, caused due to vibrations of the internal combustion engine, can be reduced, for example.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a front view of an intake manifold in one embodiment;

FIG. 2 is a sectional view of the intake manifold taken along a line II-II illustrated in FIG. 1;

FIG. 3 is a sectional view of the intake manifold taken along a line III-III illustrated in FIG. 2; and

FIG. 4 is a sectional view of an intake manifold in a modification of the embodiment.

### DETAILED DESCRIPTION OF EMBODIMENTS

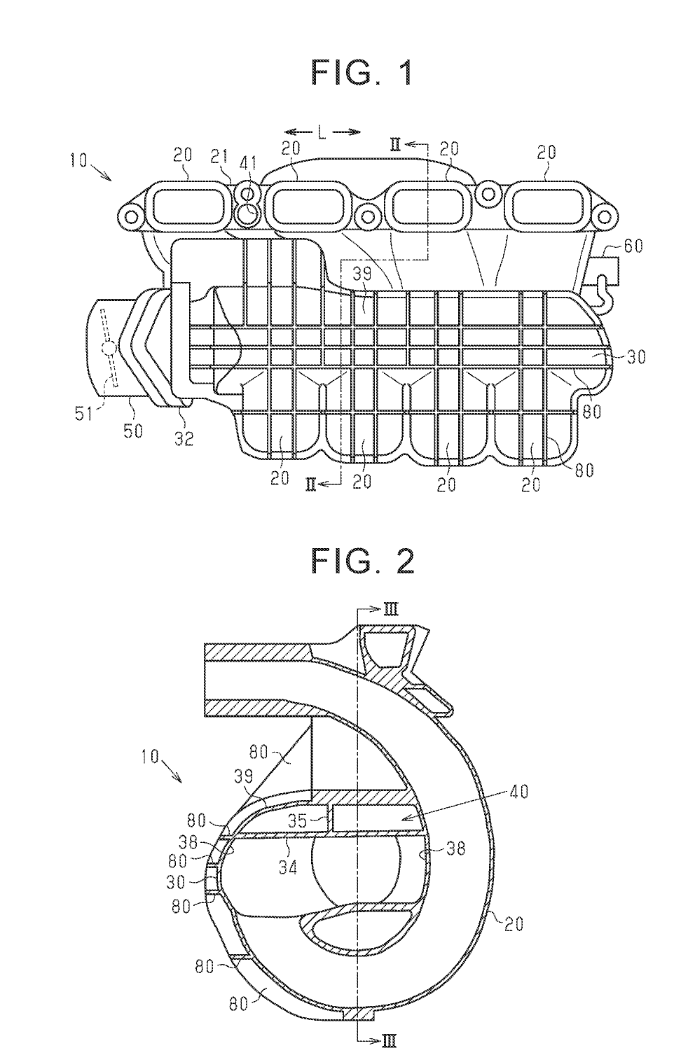

One embodiment of an intake manifold for an internal combustion engine is described below with reference to FIGS. 1 to 3. Note that an intake manifold 10 of the present embodiment is an intake manifold made of resin and assembled to an inline four-cylinder internal combustion engine.

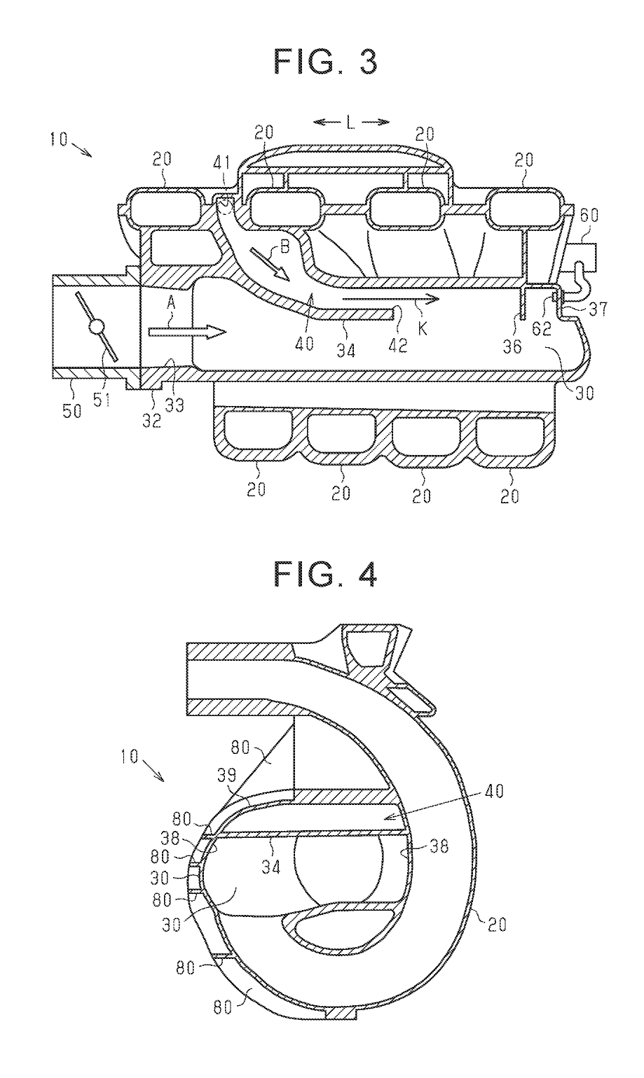

As illustrated in FIG. 1, a surge tank 30 extending in a cylinder arrangement direction (an arrow-L direction illustrated in FIGS. 1 and 3) of the internal combustion engine as an assembly target is provided in the intake manifold 10. One end, in a longitudinal direction of the surge tank (the same direction as the arrow-L direction illustrated in FIGS. 1 and 3), of the surge tank 30 extending in the cylinder arrangement direction is provided with a throttle flange 32, and a throttle body 50 including a throttle valve 51 is connected to the throttle flange 32.

As illustrated in FIGS. 1 and 2, the intake manifold 10 includes four distribution channels 20 provided as curved passages branched from the surge tank 30 and configured to distribute and supply air to respective cylinders of the internal combustion engine. Further, as illustrated in FIG. 1, a port flange 21 configured to connect the distribution channels 20 to an intake port of the internal combustion engine is provided on an intake-air downstream side of the distribution channels 20.

As illustrated in FIG. 1, a plurality of ribs 80 is formed on an external wall 39 of the surge tank 30 and external walls of the distribution channels 20. Further, the intake manifold 10 is provided with a gas inlet 41 configured to introduce blowby gas of the internal combustion engine into the surge tank 30. Note that, in the present embodiment, the gas inlet 41 is provided in the port flange 21, but the gas inlet 41 may be provided in other parts.

As illustrated in FIG. 3, an air introduction port 33 configured to introduce the air into the surge tank 30 is opened in a part where the throttle flange 32 is provided in the surge tank 30.

A gas introduction passage 40 configured to introduce blowby gas into the surge tank 30 is provided in the intake manifold 10. The gas introduction passage 40 extends in the same direction (an arrow-K direction illustrated in FIG. 3) as the longitudinal direction of the surge tank 30. In other words, the gas introduction passage 40 extends toward a direction parallel to the longitudinal direction of the surge tank 30. The gas inlet 41 is connected to an upstream side of the gas introduction passage 40 in a flow direction of the blowby gas flowing through the gas introduction passage 40. Further, a tail end of the gas introduction passage 40 on a downstream side in the flow direction of the blowby gas flowing through the gas introduction passage 40 is provided with an opening 42 opened inside the surge tank 30 on an intake-air downstream side of the air introduction port 33. The opening 42 is provided near a center of the surge tank 30 in the longitudinal direction of the surge tank. The gas introduction passage 40 is opened toward a direction distanced from the air introduction port 33, and blowby gas B flowing into the gas introduction passage 40 from the gas inlet 41 flows out from the opening 42 into the surge tank 30.

As illustrated in FIG. 2, a first rib 34 provided over an inner peripheral surface 38 of the surge tank 30 and forming a bottom wall of the gas introduction passage 40, and a second rib 35 extending upward from the first rib 34 and forming a vertical wall perpendicular to the bottom wall in the gas introduction passage 40 are formed inside the surge tank 30.

As illustrated in FIG. 3, a sensing portion 62 of a pressure sensor 60 is provided on an outer wall 37 of the surge tank 30, the outer wall 37 being positioned on an extension line of the gas introduction passage 40, which extends in a direction in which the opening of the gas introduction passage opens (an arrow-K direction illustrated in FIG. 3). A wall 36 projecting from an inner peripheral surface of the surge tank 30 is provided between the sensing portion 62 and the opening 42 of the gas introduction passage 40.

According to the present embodiment described above, it is possible to obtain the following operations and effects. (1) As illustrated in FIG. 3, air A introduced into the surge tank 30 from the air introduction port 33 flows in the longitudinal direction of the surge tank 30 toward the intake-air downstream side. Here, in the present embodiment, the gas introduction passage 40 extends in the same direction as the longitudinal direction of the surge tank 30, and does not extend in a direction inclined relative to the longitudinal direction of the surge tank 30. Accordingly, a flow direction of the blowby gas B right after introduction into the surge tank 30 from the opening 42 of the gas introduction passage 40 is the same as a flow direction of the air A flowing through the surge tank 30 in the longitudinal direction, so that the blowby gas flows toward the intake-air downstream side together with the air right after the blowby gas is introduced into the surge tank 30 from the opening 42. Accordingly, the blowby gas introduced into the surge tank 30 from the opening 42 of the gas introduction passage 40 can hardly flow toward an intake-air upstream side of the surge tank 30, thereby resulting in that an inflow of the blowby gas into the air introduction port 33 can be restrained.

(2) Inside the surge tank 30, the first rib 34 is provided over the inner peripheral surface 38 of the surge tank 30 so as to form the bottom wall of the gas introduction passage 40. Further, the second rib 35 extending upward from the first rib 34 and forming the vertical wall perpendicular to the bottom wall in the gas introduction passage 40 is also provided. Since the inner peripheral surface of the surge tank 30 is reinforced by the first rib 34 and the second rib 35, it is possible to increase rigidity of the surge tank 30 without increasing a thickness of the surge tank 30. Accordingly, it is possible to raise withstand voltage performance of the surge tank 30 while restraining a weight increase of the surge tank 30, for example

(3) In a case where the throttle body 50 including the throttle valve 51 is attached to an intake-air upstream side of the air introduction port 33, if the blowby gas introduced into the surge tank 30 flows into the air introduction port 33, the following inconvenience might be caused.

That is, if the blowby gas flowing into the air introduction port 33 reaches the throttle body 50 attached to the intake-air upstream side of the air introduction port 33, the throttle valve 51 and an intake passage near the throttle valve 51 are exposed to the blowby gas. Here, under a low temperature environment, steam included in the blowby gas might be turned into condensed water and then frozen. Accordingly, when the blowby gas reaches the throttle body 50 under such a low temperature environment, condensed water derived from the blowby gas attached to the throttle valve 51 and the intake passage near the throttle valve 51 is frozen, which might cause malfunction of the throttle valve 51.

In this regard, with the intake manifold 10 of the present embodiment, it is possible to restrain the inflow of the blowby gas into the air introduction port 33 as described above, thereby making it possible to restrain an occurrence of the malfunction of the throttle valve 51 as described above.

(4) If the sensing portion 62 of the pressure sensor 60 is provided on the outer wall 37 of the surge tank 30, the outer wall 37 being positioned on the extension line of the gas introduction passage 40, which extends in a direction in which the opening of the gas introduction passage opens. The sensing portion 62 is easily exposed to the blowby gas. Here, as described above, under a low temperature environment, steam included in the blowby gas might be turned into condensed water and then frozen. Accordingly, when the sensing portion 62 is exposed to the blowby gas under such a low temperature environment, condensed water derived from the blowby gas attached to the sensing portion 62 might be frozen, so that detection accuracy of the pressure sensor 60 might decrease. In this regard, in the present embodiment, the wall 36 projecting from the inner peripheral surface of the surge tank 30 is provided between the sensing portion 62 and the opening 42 of the gas introduction passage 40, so that the wall 36 restrains the sensing portion 62 from being exposed to the blowby gas. This accordingly makes it possible to restrain the decrease of the detection accuracy of the pressure sensor 60. Further, since the wall 36 projecting from the inner peripheral surface of the surge tank 30 functions as a rib that reinforces the inner peripheral surface of the surge tank 30, it is possible to increase rigidity of the surge tank 30 without increasing a thickness of the surge tank 30. Accordingly, vibrations of the surge tank 30, caused due to vibrations of the internal combustion engine, can be reduced, for example.

The foregoing embodiment may also be carried out by adding changes as stated below. The sensing portion 62 and the wall 36 may be omitted. Further, the wall 36 may be omitted in a case where the sensing portion 62 is provided on the outer wall 37 of the surge tank 30. Even with those modifications, it is possible to yield the above operations and effects other than (4).
As illustrated in FIG. 4, the gas introduction passage 40 may be provided between the first rib 34 and the external wall 39 of the surge tank 30, and the second rib 35 may be omitted. The opening 42 of the gas introduction passage 40 is provided near the center of the surge tank 30 in the longitudinal direction of the surge tank. However, the opening 42 may be provided in other parts, e.g., a part on the intake-air upstream side relative to the center of the surge tank 30 in the longitudinal direction, a part on the intake-air downstream side relative to the center of the surge tank 30 in the longitudinal direction, and so on.

The intake manifold 10 is an intake manifold assembled to an inline four-cylinder internal combustion engine, but may be an intake manifold for a multi-cylinder internal combustion engine having other cylinder arrangements or including other numbers of cylinders.

What is claimed is:

1. An intake manifold for an internal combustion engine, the intake manifold comprising:
a surge tank extending in a cylinder arrangement direction of the internal combustion engine, wherein
the surge tank includes an air introduction port configured to introduce air into the surge tank, the air introduction port being provided on one end, in a longitudinal direction of the surge tank, of the surge tank extending in the cylinder arrangement direction;
the surge tank includes a gas introduction passage configured to introduce blowby gas of the internal combustion engine into the surge tank, the gas introduction passage having an opening inside the surge tank on an intake-air downstream side of the air introduction port; and
the gas introduction passage extends in the same direction as the longitudinal direction of the surge tank.

2. The intake manifold according to claim 1, wherein:
the surge tank includes a rib provided inside the surge tank to define the gas introduction passage; and
the rib is provided over an inner peripheral surface of the surge tank.

3. The intake manifold according to claim 1, further comprising:
a throttle body including a throttle valve, the throttle body being attached to an intake-air upstream side of the air introduction port.

4. The intake manifold according to claim 1, further comprising:
a sensing portion of a sensor provided on an outer wall of the surge tank, the outer wall being positioned on an extension line of the gas introduction passage, the extension line extending in a direction in which the opening of the gas introduction passage opens,
wherein the surge tank includes a wall projecting from an inner peripheral surface of the surge tank, the wall being provided between the opening of the gas introduction passage inside the surge tank and the sensing portion.
